(19) United States
(12) Patent Application Publication
(10) Pub. No.: US 2017/0040796 A1
(43) Pub. Date: Feb. 9, 2017

(54) COMMUNICATION SYSTEM IN AN ELECTRICAL FACILITY INCLUDING BATTERIES

(71) Applicants: Commissariat à I'Energie Atomique et aux Energies Alternatives, Paris (FR); Novea Energies, Beaucouze (FR); Universite de Nantes, Nantes Cedex 1 (FR)

(72) Inventors: Jérémie JOUSSE, Angers (FR); Nicolas GINOT, Champtoceaux (FR); Christophe BATARD, Carquefou (FR); Jean-Pierre BELLIARD, La Membrolle-sur-Longuenee (FR)

(21) Appl. No.: 15/303,219

(22) PCT Filed: Mar. 27, 2015
(86) PCT No.: PCT/EP2015/056809

§ 371 Date: Oct. 10, 2016

(30) Foreign Application Priority Data
Apr. 10, 2014 (FR) 1453188

(51) Int. Cl. H02J 1/00; H02J 7/00

(52) U.S. Cl. CPC H02J 1/00; H02J 7/0013; H02J 7/0014; H04Q 9/06

(57) ABSTRACT

The invention relates to a system which includes: a plurality of batteries (B1, B2) connected in parallel by a pair of first (1⁺) and second (1⁻) power conductor, each battery being connected to a device (BMS1, BMS2) for managing the battery; a device (EMS) for global energy management; a generator (101) suitable for applying an alternating signal to the power conductors (1⁺, 1⁻); and a plurality of transmitter-receiver circuits (M) respectively connected to the various management devices (EMS, BMS1, BMS2), each transmitter-receiver circuit (M) being connected to the power conductor (1⁺, 1⁻) and being suitable, in order to transmit data, for switching the impedance thereof between the power conductors (1⁺, 1⁻) between two states, and, in order to receive data to detect whether a value representing the amplitude of the alternating signal on said power conductors (1⁺, 1⁻) is higher or lower than a threshold.

The present patent application claims the priority benefit of French patent application FR14/53188 which will be incorporated herein by reference.

### BACKGROUND

The present application relates to data communication between management devices in an electrical facility comprising a plurality of batteries connected in parallel by a pair of power conductors.

### DISCUSSION OF THE RELATED ART

A battery is a group of a plurality of rechargeable elementary cells (cells, accumulators, etc.) connected in series and/or in parallel between two DC voltage supply nodes or terminals. A battery is generally associated with a battery management system or device, BMS, that is, an electronic circuit capable of implementing various functions such as functions of battery protection during charge or discharge phases, battery cell balancing functions, functions of battery cell temperature monitoring, functions of battery state-of-charge and or state-of-aging monitoring, etc. The management device may be connected to the battery voltage supply terminals and/or to internal nodes of the battery. The elementary cells of a battery and the management device associated with this battery are often housed in a same protection package leaving access to two lugs respectively connected to the two battery voltage supply terminals. The assembly comprising the protection package, the battery cells, and the battery management device is generally called “battery pack”.

In certain applications, a plurality of batteries are connected in parallel by a pair of power conductors, to power a load and/or to be charged by an electric power source. In such applications, an energy management system or device, EMS, is generally provided, in particular to provide functions of protection of the facility and/or of monitoring of the state of the different batteries. The EMS should be able to poll the BMSs of the different batteries to obtain information relative to the state of the batteries. Generally. BMSs should further be able to communicate with one another and/or with the EMS, for example, to exchange information of power distribution type, current limitation request, etc.

To achieve this, a wire communication between the EMS and the BMSs to be polled is generally used. A specific connector connected to the BMS of each battery may for example be provided outside of each battery pack to form the wire connection. A disadvantage then is the need to provide additional connectors and/or cables (in addition to power conductors) between the EMS and the battery packs, which may raise various problems, particularly in terms of cost, of mechanical robustness, etc.

To avoid the disadvantages of a wire communication, communications by radio waves (contactless) between the EMS and the BMSs could be used. The use of radio communications however also has disadvantages, particularly in terms of cost, of complexity, of power consumption, etc.

It would be desirable to have reliable, simple and inexpensive means to enable an energy management device or EMS to communicate with battery devices or BMSs, in a system comprising a plurality of batteries connected in parallel by a pair of power conductors.

### SUMMARY

To achieve this, an embodiment provides a system comprising: a plurality of batteries, each comprising a plurality of elementary cells connected between two DC voltage supply terminals, said batteries being connected in parallel by a pair of first and second power conductors, each battery being connected to a battery management device; an energy management device for the system; a generator capable of applying a first AC carrier signal to said power conductors; and a plurality of transceiver circuits respectively connected to the different management devices, each transceiver circuit being connected to said power conductors and being capable, to transmit data, of switching between two states its impedance between said power conductors for said first signal, to modulate the amplitude of said first signal and, to receive data, of detecting whether a value representative of the amplitude of said first signal is greater than or smaller than a threshold.

According to an embodiment, each battery is connected to said power conductors via an end inductance.

According to an embodiment, the system further comprises at least one load or electric energy source connected to the batteries via the pair of power conductors.

According to an embodiment, the load or source is connected to the power conductors via an end inductance.

According to an embodiment, each transceiver circuit comprises, between a first node of connection of the circuit to the first power converter and a second node of connection of the circuit to the second power conductor, a branch comprising a swatch in series with a first resistor and, in parallel with this branch, a second resistor.

According to an embodiment, each transceiver circuit comprises, between the first node and an intermediate node, a decoupling capacitor, the branch and the second resistor being connected between the intermediate node and the second node.

According to an embodiment, each transceiver circuit comprises a receive circuit comprising two input terminals connected across the second resistor, the receive circuit being capable of supplying, on an output terminal, a binary signal representative of the amplitude level of an AC signal across the second resistor.

According to an embodiment, the generator is connected to the power conductors via a decoupling capacitor.

According to an embodiment, the generator is capable of applying to the power conductors a periodic frequency signal such that the wavelength of the periodic signal is greater than eight times the maximum length of said pair of power conductors.

According to an embodiment, the energy management device is connected to the generator and is capable of controlling the generator to apply an AC signal to the pair of power conductors only during phases of polling of the battery management devices, and of keeping the generator at stand-by for the rest of the time.

According to an embodiment, each transceiver circuit is coupled to the management device which is associated therewith via a CAN controller.

### BRIEF DESCRIPTION OF THE DRAWINGS

The foregoing and other features and advantages will be discussed in detail in the following non-limiting description of dedicated embodiments in connection with the accompanying drawings, among which:

FIG. 1 schematically shows an embodiment of a system comprising a plurality of batteries connected in parallel by a pair of power conductors, and a device of general management of the system energy;

FIG. 2 schematically and partially illustrates an example of a communication network of known type;

FIG. 3 shows in more detailed fashion an embodiment of a transceiver circuit of the system of FIG. 1; and

FIG. 4 shows in more detail an embodiment of a receive circuit of the transceiver circuit of FIG. 3.

### DETAILED DESCRIPTION

For clarity, the same elements have been designated with the same reference numerals in the different drawings.

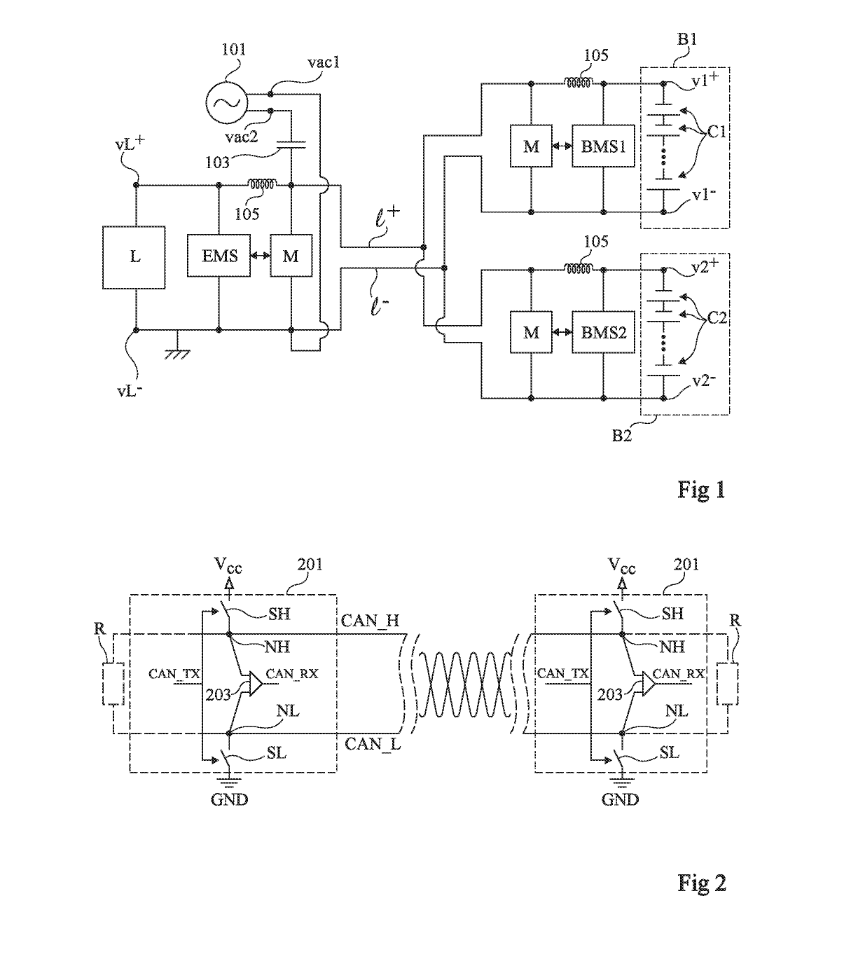

FIG. 1 schematically shows an embodiment of a system comprising a plurality of batteries connected in parallel by a pair of power conductors. In the show n example, the system comprises two batteries B1 and B2 connected in parallel. It will however be within the abilities of those skilled in the art to adapt the described embodiments to applications comprising a number of batteries m parallel greater than two. Battery B1 comprises a plurality of elementary cells C1 connected in series and/or in parallel between positive and negative DC voltage supply terminals v1⁺ and v1⁻ and battery B2 comprises a plurality of elementary cells C2 connected in series and/or in parallel between positive and negative DC voltage supply terminals v2⁺ and v2⁻. The positive terminals v1⁺ and v2⁺ of batteries B1 and B2 are connected together by a power conductor 1⁺, and the negative terminals v1⁻ and v2⁻ of batteries B1 and B2 are connected together by a power conductor 1⁻. Conductors 1⁺ and 1⁻ form a pair of power conductors connecting batteries B1 and B2 in parallel. In this example, conductors 1⁺ and 1⁻ are further respectively connected to positive and negative power supply terminals vL⁺ and vL⁻ of a load L.

Each battery of the system of FIG. 1 is coupled to a device for managing the battery or BMS, respectively BMS1 for battery B1 and BMS2 for battery B2. In the shown example, device BMS1 for managing battery B1 is connected to battery B1 only via voltage supply terminals v1⁺ and v1⁻ of battery B1, and device BMS2 for managing battery B2 is connected to battery B2 only via voltage supply terminals v2⁺ and v2⁻ of battery B2. The described embodiments are however not limited to this specific case. As a variation, it is possible for the BMS associated with each battery not to be connected to the main voltage supply terminals of the battery, but to be only connected to connection nodes internal to the battery, or to be connected both to the main voltage supply terminals of the battery and to connection nodes internal to the battery, and/or to be connected to conductors 1⁺ and 1⁻.

The system of FIG. 1 further comprises an energy management device EMS. In the shown example, energy management device EMS is connected to power supply terminals vL⁺ and vL⁻ of load L. The described embodiments are however not limited to this specific case.

As explained hereafter, it would be desirable for energy management device EMS to be able to communicate with management devices BMS1 and BMS2 of batteries B1 and B2 and/or for devices BMS1 and BMS2 to communicate together or with device EMS.

According to an aspect of the described embodiments, it is provided to use the power bus formed by the pair of conductors 1⁺ and 1⁻, inherently present in any electrical facility comprising batteries connected in parallel, to transport data.

To achieve this, the system of FIG. 1 comprises an AC signal generator 101, or carrier generator, capable of applying an AC signal on power conductors 1⁺ and 1⁻ of the system, that is, to transmit, over the power path of the system, an AC signal (or carrier signal) superimposed to the DC voltage of the batteries. In the shown example, generator 101 supplies an AC voltage between terminals vac1 and vac2, terminal vac1 being connected to conductor 1⁻, and terminal vac2 being connected to conductor 1+ via an isolating or decoupling capacitor 103. The function of capacitor 103 is to conduct the AC signal generated by generator 101 towards power bus 1⁺/1⁻, while preventing generator 101 from seeing the DC voltage of the batteries.

The system of FIG. 1 further comprises, at the ends of the pair of power conductors 1⁺/1⁻ (between conductors 1⁺/1⁻ and the terminals of batteries B1 and B2 and between conductors 1⁺/1⁻ and the terminals of load L), end inductances 105 having the function of conducting the DC supply terminals between batteries B1 and B2 and load L, and of preventing the passing of the AC carrier signal of power bus 1⁺/1⁻ towards batteries B1 and B2 or towards load L, especially to avoid for the carrier signal to be absorbed or to be attenuated by batteries B1 and B2 or by load L. More particularly, in the shown example, a first inductance 105 connects conductor 1⁺ to terminal v1⁺, a second inductance 105 connects conductor 1⁺to terminal v2⁺, and a third inductance 105 connects conductor 1⁺ to terminal vL⁺.

The system of FIG. 1 further comprises, connected to each of management devices EMS, BMS1 and BMS2, a transceiver circuit or modem M (that is, three circuits M in the shown example). Each of transceiver circuits M is connected to power conductors 1⁺ and 1⁻, and is capable, to transmit data, of switching between two values its impedance between conductors 1⁺ and 1⁻ for the AC component of the signal carried by conductors 1⁺ and 1⁻, and, to receive data, of detecting whether the amplitude of the AC component of the signal carried by conductors 1⁺ and 1⁻ is greater or smaller than a threshold.

It would further be desirable to have a system of communication between the BMSs and energy management device EMS compatible with the CAN communication protocol (“Controller Area Network”), particularly described in standard ISO 11898, so that the system can be implemented by using standard CAN controllers for the management of communications between energy management device EMS and the BMSs.

In order for the system of FIG. 1 to be compatible with the CAN communication protocol, particularly to be able to use standard CAN controllers to manage communications, certain constraints are to be respected.

FIG. 2 schematically shows an example of a conventional CAN communication network. In such a network, the physical support used for the data transport is a differential pair, generally called CAN bus, comprising a conductor CAN_H and a conductor CAN_L. At the ends of the differential pair, end resistors R may connect conductors CAN_H and CAN_L as shown in FIG. 2. A plurality of identical transceiver circuits 201 may be connected to the differential pair, the different circuits 201 being capable of being associated with different appliances (not shown) capable of communicating with one another. For simplification, only two transceiver circuits 201 have been shown in FIG. 2. Each circuit 201 comprises, between a node NH of connection of circuit 201 to conductive CAN_H and a node of application of a high reference potential V_{CC}, a switch SH, and, between a node NL of connection of circuit 201 to conductor CAN_L and a node of application of a low reference potential GND (which will be arbitrarily considered herein as being equal to 0 V), a switch SL. The control nodes of switches SH and SL of a same circuit 201 are connected to a same node of application of a binary control signal CAN_TX. Each circuit 201 further comprises a receive stage 203 capable of detecting whether the voltage between nodes NH and NL is greater or smaller than a threshold, and of supplying, on an output node CAN_RX, a binary signal having its state depending on the result of the detection.

The CAN network of FIG. 2 operates as follows. The binary information transmitted over bus CAN is encoded by the potential difference between conductors CAN_L and CAN_H. When switches SH and SL of all the transceiver circuits 201 connected to the differential pair are in the off state (non-conductive), the potentials of conductors CAN_L and CAN_H are set to a median potential equal to V_{CC}/2 via voltage dividing bridges (not shown) internal to circuits 201. The potential difference between conductors CAN_L and CAN_H is thus approximately zero. Each circuit 201 is capable, by simultaneously turning on its switches SL and SH, of pulling the potentials of conductors CAN_H and CAN_L respectively to potential V_{CC} and to potential GND, thus increasing the potential difference between conductors CAN_H and CAN_L in a way detectable over the entire bus. When the channel is idle (switches SL and SH of the different circuits 201 are in the off state), the potential difference between conductors CAN_H and CAN_L is at a relatively low level. It is a recessive state, interpreted in the CAN protocol as a high logic level. When at least one circuit 201 has its switches SL and SH in the on state, the potential difference between conductors CAN_H and CAN_L is at a relatively high level. It is a dominant state, interpreted in the CAN protocol as a low logic level. During a phase of data reading over the CAN bus by a circuit 201, switches SH and SL of the circuit are controlled to the off state. The voltage level between conductors CAN_L and CAN_H of the CAN bus can then be compared with a threshold by receive stage 203, which supplies on output node CAN_RX a binary signal representative of the result of this comparison.

The respectively dominant and recessive characters of the low and high logic levels are at the core of the CAN protocol operation, and are particularly used to manage the sharing of the communication channel by a plurality of appliances, each connected to a circuit 201.

In practice, a control circuit or CAN controller forms an interface between each communicating appliance and the transceiver circuit 201 associated with the appliance. The CAN controller comprises an output pin connected to input CAN_TX of circuit 201, and an input pin connected to output CAN_RX of circuit 201. Controller CAN is capable of receiving data from the associated appliance and of controlling circuit 201 to transmit the data over bus CAN, and/or of receiving data from circuit 201 and of supplying the data to the associated appliance. The software management of communications may be performed by the CAN controller, for example, according to standard ISO 11898.

To be able to use standard CAN controllers to manage communications in a system of the type described in relation with FIG. 1, the communication channel should be able to have a dominant state, corresponding to a first logic level, and a recessive state, corresponding to a second logic level. This condition is respected in the system of FIG. 1, particularly due to the fact that the system comprises a single carrier generator 101 common to a plurality of transceiver circuits M.

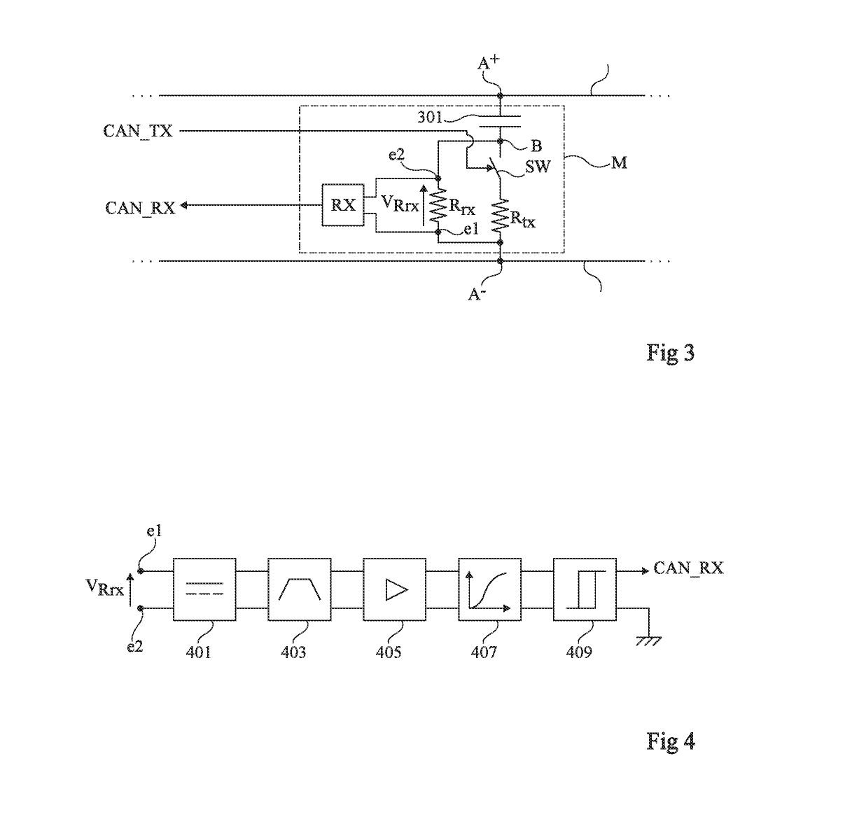

FIG. 3 shows in further detail an embodiment of a transceiver circuit M of the system of FIG. 1. In practice, all circuits M of the system of FIG. 1 may be identical or similar.

Circuit M comprises a node (or terminal) A⁺ intended to be connected to conductor 1⁺, and a node (or terminal) A⁻ intended to be connected to conductor 1⁻. In this example, circuit M comprises, between node A⁺ and a node B, a capacitor 301, and further comprises, in series between node B and node A⁻, a switch SW and a resistor Rₜₓ, and, in parallel with the branch comprising switch SW and resistor Rₜₓ, a resistor Rᵣₓ connecting node B to node A⁻. As a non-limiting example, resistor Rₜₓ and switch SW may belong to a same switching element, for example, a MOS transistor, resistor Rₜₓ then being the internal on-state resistance of the MOS transistor. Capacitor 301 is an isolating or decoupling capacitor having the function of conducting the AC signal generated by generator 101 towards node B of circuit M, while preventing for node B to see the DC voltage of the batteries.

When switch SW of circuit M is in the on conductive state), the impedance of circuit M between conductors 1⁺ and 1⁻, for the AC component of the signal carried by conductors 1⁺ and 1⁻, is in a low state, and, when switch SW of circuit M is in the off (non conductive) state, the impedance of circuit M between conductors 1⁺ and 1⁻, for the signal carried by conductors 1⁺ and 1⁻, is in a high state.

The control node of switch SW is connected to an input node CAN_TX of circuit M, capable of receiving a binary control signal. Circuit M further comprises a receive circuit RX connected across resistor Rᵣₓ, the circuit being capable of detecting whether the amplitude of the AC voltage between nodes B and A⁻ is greater than or smaller than a threshold, and of supplying, on an output node CAN_RX of circuit M, a binary signal having its state depending on the result of the comparison.

The communication system of FIG. 1 operates as follows. The binary data transmitted on the pair of power conductors 1⁺/1⁻ or power bus are encoded by the amplitude of the AC signal supported by the power bus. When the switches SW of all transceiver circuits M connected to the power bus are in the off (non-conductive) state, the amplitude of the AC component of the signal carried by the power bus is at a high level. Each circuit M is capable, by turning on its switch SW, of decreasing its impedance between conductors 1⁺ and 1⁻ for the AC component of the signal carried by the power bus, thus decreasing the amplitude of the AC signal carried by the power bus in detectable fashion over the entire bus. When the channel is idle (the switches SW of the different circuits M are off), the amplitude of the AC signal on the power bus is at a relatively high level. It is a recessive state since this state is only obtained when all devices M are in a high impedance state. This state may be interpreted as a high logic level. When at least one circuit M has its switch SW on, the amplitude of the AC signal on the power bus is at a relatively low level. It is a dominant state, since this state is obtained as soon as at least one circuit M is in a low impedance state. This state may be interpreted as a low logic level. During a phase of data reading over the power bus by a circuit M, switch SW of the circuit is controlled to the off state. The amplitude level of AC voltage V_{Rrx} across resistor Rᵣₓ of circuit M, representative of the amplitude level of the carrier signal over the power bus, may then be compared with a threshold by circuit RX, which supplies on output node CAN_RX of circuit M a binary signal representative of the result of this comparison.

Thus, the behavior of the system of FIG. 1 has the respectively dominant and recessive characters of the high and low logic levels, such as they exist in a CAN network of the type described in relation with FIG. 2.

An advantage of the system of FIG. 1 is that it is compatible with standard CAN controllers, which may for example be connected to form an interface between the different communicating appliances of the network, that is, management devices EMS, BMS1, and BMS2 in the shown example, and the transceiver circuits M associated with the appliance. As an example, input CAN_TX and output CAN_RX of each circuit M may be respectively connected to an output pin (or transmit pin) or an input pin (or receive pin) of a standard CAN controller. As a non-limiting example, CAN controllers (not shown) may be integrated in management devices EMS, BMS1, and BMS2. The software management of communications can thus be fully provided by the standard CAN management stack integrated to the CAN controllers. It should be noted that a logic inversion circuit, not shown, may possibly be provided to form an interface between the output of the CAN controller and input CAN_TX of circuit M to ensure the compatibility with the signals originating from the CAN controller (particularly according to the type of switch SW used).

FIG. 4 schematically shows, in the form of blocks, a non-limiting embodiment of receive circuit RX of circuit M of FIG. 3.

Circuit RX of FIG. 4 comprises a biasing stage 401 intended to be connected across resistor Rᵣₓ via nodes or terminals e1 and e2. Stage 401 takes part in the impedance of circuit M between conductors 1⁺ and 1⁻ for the AC carrier signal, and outputs an AC voltage centered on V_{DD}/2, V_{DD} being a local voltage for powering circuit M. Stage 401 further performs an impedance matching with a follower amplifier to limit the impact of the measurement on the channel. Circuit RX of FIG. 4 further comprises, at the output of stage 401, a filtering stage 403, for example, a third-order Butterworth bandpass filter, capable of filtering possible parasitic signals located outside of the frequency band of the carrier signal. Circuit RX of FIG. 4 further comprises, at the output of stage 403, an amplification stage 405 enabling to obtain a dynamic range compatible with the downstream processing stages. Circuit RX of FIG. 4 further comprises, at the output of stage 405, a stage 407 for measuring the power of the AC signal in the sampled frequency band. The use of a power measurement indeed enables to obtain a logarithmic measurement representative of the amplitude of the AC signal, more sensitive than a simple peak measurement. Circuit RX of FIG. 4 further comprises, at the output of stage 407, a stage 409 of comparison with a measurement threshold of the power supplied by stage 407. The comparison threshold may be fixed or self-adjustable. The comparator output may be connected to output CAN_RX of circuit M.

The tests performed by the inventors have shown that, in a system of the type described in relation with FIG. 1, the AC carrier signal propagated over the power bus of the electrical facility is submitted to local attenuations and/or amplifications due to interferences with waves reflected at the ends of the power bus. The AC signal carried by the power bus then has local maximum and minimum values distributed on the transmission line at distances which are multiples of λ/4, λ being the wavelength of the carrier signal, with λ=V_{φ}/f, where V_{φ}is the propagation speed of the AC signal in the conductor, and f the frequency of the AC signal. Such minimum and maximum values are equivalent to local inversions of the impedance of the transmission line, and locally cause an inversion of the dominant and recessive levels of the AC signal, preventing the reconstruction of the original signal. Such parasitic reflection phenomena are all the stronger as the number of nodes or number of circuits M on the network is large.

The inventors have however determined that such parasitic disturbances do not prevent a correct reconstruction of the data signals when the total or maximum length of the power bus used as a data transmission line is smaller than or equal to λ/8, λ being the wavelength of the carrier signal.

As a non-limiting example, in a system where the total length of the power bus is 3 meters, and for a phase speed V_{φ}=155*10⁶ m·s⁻¹, it is obtained that the frequency of the carrier signal should preferably be smaller than approximately 6.5 MHz. In practice, frequency f of the carrier signal is selected to be such that the signal level difference between the recessive state and the dominant state is close to a maximum peak, for example, equal to within 20% to the frequency at which the signal level difference between the recessive state and the dominant state is maximum. Such a frequency may for example be determined by simulation based on the different characteristics of the system.

As previously indicated, end impedances 105 are sized to have a low impedance in DC state to minimize losses by Joule effect, while having a high impedance at the frequency of the carrier signal, to limit the attenuation of the carrier signal by the different appliances connected to the power bus. A compromise should further be found between the value of the inductances, the bulk, the series resistance, and the cost thereof. The inventors have determined that, for many applications, end inductances 105 having a value in the range from 10 to 30 μH provide a satisfactory compromise.

An advantage of the provided system is that it does not require providing a wire connection specifically dedicated to the communication between the different devices for managing the electrical facility, and that it docs not require providing wireless communication units either.

Another advantage is that this system is compatible with standard CAN controllers, as explained hereabove.

Further, in the provided system, transceiver circuits M are generic, that is, they need not be adapted when the frequency of the carrier signal changes. Thus, the same circuits M may be used in facilities having different cable lengths and/or different numbers of communicating appliances. Only the frequency of the carrier signal should possibly be modified if the cable length significantly changes.

Specific embodiments have been described. Various alterations, modifications, and improvements will readily occur to those skilled in the art.

In particular, in the example shown in FIG. 1, generator 101 of the carrier signal is connected to power bus 1⁺/1⁻ in the vicinity of general management device EMS. The described embodiments are not limited to this specific case. More generally, generator 101 may be connected at any point of the power bus. Advantageously, without it being a limitation, generator 101 may be driven by energy management device EMS, which may for example choose to control it to transmit a carrier signal on the power bus only when it desires to poll the BMSs, and to keep it at stand-by for the rest of the time in order to save power.

Further, for certain high-power applications using high DC voltages on the power bus, an additional isolating stage (transformer, capacitive link, optocoupler, etc.) may be added between transceiver circuits M and batteries B1 and B2 or load L.

Further, the described embodiments are not limited to a specific waveform for the AC carrier signal generated by generator 101. As non-limiting examples, generator 101 may supply a sinusoidal signal, a triangular signal, a rectangular signal, or any other periodic AC signal having its fundamental frequency meeting the above-mentioned criteria.

Further, the amplitude of the carrier signal is not necessarily voltage-controlled but may as a variation be current-controlled.

Further, the described embodiments are not limited to the case where generator 101 transmits at a determined fixed frequency f before the deployment of the system. As a variation, generator 101 may be capable of generating a plurality of frequencies, and the system may implement an initialization phase during which a plurality of carrier frequencies are tested to select a frequency allowing a satisfactory communication. Similarly, in the case where receive circuits RX of transceiver circuits M comprise a frequency filter (such as in the example of FIG. 4), the filter may be self-adjustable so that its bandwidth automatically centers on the fundamental frequency of the carrier signal.

It should further be noted that in the example of FIG. 1, load L may be replaced with a power source. More generally, the provided solution is compatible with a system comprising one or a plurality of loads and/or one or a plurality of power sources connected to the pair of power conductors 1⁺/1⁻.

1. A system comprising:
a plurality of batteries (B1, B2), each comprising a plurality of elementary cells (C1, C2) connected between two DC voltage supply terminals (v1⁺, v1⁻, v2⁺, v2⁻), said batteries being connected in parallel by a pair of first (1⁺) and second (1⁻) power conductors, each battery being connected to a battery management device (BMS1, BMS2);
an energy management device (EMS) for the system;
a generator capable of applying a first AC carrier signal to said power conductors (1⁺, 1⁻); and
a plurality of transceiver circuits (M) respectively connected to the different management devices (EMS, BMS1, BMS2), each transceiver circuit (M) being connected to said power conductors (1⁺, 1⁻) and being capable, to transmit data, of switching between two states its impedance between said power conductors (1⁺, 1⁻) for said first signal, to modulate the amplitude of said first signal and, to receive data, of detecting whether a value representative of the amplitude of said first signal is greater than or smaller than a threshold.

2. The system of claim 1, wherein each battery (B1, B2) is connected to said power conductors (1⁺, 1⁻) via an end inductance.

3. The system of claim 1, further comprising at least one load (L) or electric energy source connected to the batteries (B1, B2) via the pair of power conductors (1⁺, 1⁻).

4. The system of claim 3, wherein said at least one load (L) or source is connected to said power conductors (1⁺, 1⁻) via an end inductance.

5. The system of claim 1, wherein each transceiver circuit (M) comprises, between a first node (A⁺) of connection of the circuit to the first power converter (1⁺) and a second node (A⁻) of connection of the circuit to the second power conductor (1⁻), a branch comprising a switch (SW) in series with a first resistor (Rₜₓ) and, in parallel with this branch, a second resistor (Rᵣₓ).

6. The system of claim 5, wherein each transceiver circuit (M) comprises, between the first node (A⁺) and an intermediate node (B), a decoupling capacitor, said branch (SW, Rₜₓ) and said second resistor (Rᵣₓ) being connected between the intermediate node (B) and the second node (A⁻).

7. The system of claim 5, wherein each transceiver circuit (M) comprises a receive circuit (RX) comprising two input terminals (e1, e2) connected across the second resistor (Rᵣₓ), the receive circuit (RX) being capable of supplying, on an output terminal (CAN_RX), a binary signal representative of the amplitude level of an AC signal across the second resistor (Rᵣₓ).

8. The system of claim 1, wherein the generator is connected to said power conductors (1⁺, 1⁻) via a decoupling capacitor.

9. The system of claim 1, wherein the generator is capable of applying to said power conductors (1⁺, 1⁻) a periodic frequency signal such that the wavelength (λ) of the periodic signal is greater than eight times the maximum length of said pair of power conductors (1⁺, 1⁻).

10. The system of claim 1, wherein the energy management device (EMS) is connected to the generator and is capable of controlling the generator to apply an AC signal to the pair of power conductors (1⁺, 1⁻) only during phases of polling of the battery management devices (BMS1, BMS2), and of keeping the generator at stand-by for the rest of the time.

11. The system of claim 1, wherein each transceiver circuit (M) is coupled to management device (EMS, BMS1, BMS2) which is associated therewith via a CAN controller.
